(19) United States
(12) Patent Application Publication
(10) Pub. No.: US 2015/0070881 A1
(43) Pub. Date: Mar. 12, 2015

(54) LED LIGHT TUBE OF MODULE TYPE

(71) Applicant: GEM WELTRONICS TWN CORPORATION, Hsinchu County (TW)

(72) Inventors: JON-FWU HWU, Hsinchu County (TW); YUNG-FU WU, Hsinchu County (TW); KUI-CHIANG LIU, Hsinchu County (TW)

(73) Assignee: GEM WELTRONICS TWN CORPORATION, Hsinchu County (TW)

(21) Appl. No.: 14/019,625

(22) Filed: Sep. 6, 2013

(51) Int. Cl. F21V 29/00; F21K 99/00

(52) U.S. Cl. CPC F21V 29/22; F21K 9/30; F21K 9/50; F21V 29/2206
USPC 362/218

(57) ABSTRACT

An LED light tube includes a modularized LED base having a recess, one illumination unit and one bridging unit being fixed in the recess, the illumination unit being constituted by LED dies and the bridging unit being constituted by conductive elements electrically connecting the LED dies; a heat dissipation base for receiving and supporting the modularized LED base thereon; a circuit unit disposed on the dissipation base to locate adjacent to one side of the recess; an optical layer covering the illumination unit and the bridging unit; a protection layer covering the optical layer; and a diffusion shield disposed above the dissipation base and having two peripheral sides formed with downwardly and inwardly bent projections slidably engaging two sliding grooves of the dissipation base, thereby enclosing the LED dies therein such that the diffusion shield is located above and transversely to a light emitting path of the LED dies.

### BACKGROUND OF THE INVENTION

1. Field of the Invention

The present invention relates to a light emitting diode (LED) light tube, more particularly to a module type integrally formed LED light tube including a modularized LED base and a modularized wire-holding frame unit.

2. The Prior Arts

Owing to high efficiency, long lasting, small size, low energy consuming, swift in response, and mature advance in the modern electronics lately, a majority of traditional light bulbs or light tubes are gradually replaced with LED light tubes. It is in the trend of research how to apply the LEDs in the mostly and highly used fluorescent lamps.

A prior art LED light tube generally includes a light tube, a heat dissipation plate, a printed circuit board, a plurality of LED units and two conductive caps. The heat dissipation plate is mounted within the light tube while the printed circuit board is mounted on the heat dissipation plate. The LED units are connected electrically with the printed circuit board.

During the assembly, the LED units are first of all soldered on the printed circuit board, after which, the LED units and the printed circuit board are mounted on the heat dissipation plate via assembly elements. The above-mentioned elements are available in form of finished products, wherein the LED units are manufactured from wafer by high-tech companies, the dies by the medium size companies while the packing is done by small size companies. In addition, the printed circuit board is fabricated via etching, exposure process and coating process.

### SUMMARY OF THE INVENTION

A prior art LED light tube includes a plurality of LED units and a printed circuit plate which are fabricated through several processes and they are assembled together so as to form the LED light tube. The preceding several processes and assembly process and several structure of the LED units and the printed circuit plate are in fact not directly related to the LED light tube so that an overall manufacturing cost thereof cannot be reduced, thereby wasting a relatively large amount of materials.

Regarding an LED unit, the high tech companies usually fabricated wafers, which are transported to medium size companies, where the wafer is fabricated into LED dies, each of which is again wire bond and is molded by small size companies via molded compound to produce as the LED unit. It is noted that a large amount of molded compound consisting of fluorescent glue is required to conduct the molded process. The manufacturing cost is therefore high and consequently results in long manufacturing time.

The main objective of the present invention is to provide a module type integrally formed LED light tube. The module type integrally formed LED light tube of the present invention accordingly includes a modularized LED base having a light emitting side formed with a recess, at least one illumination unit and at least one bridging unit being fixed on a bottom surface of the recess, the illumination unit and the bridging unit being connected electrically via wire-bond technique, wherein the illumination unit is constituted by a plurality of LED dies and the bridging unit is constituted by a plurality of conductive elements, one conductive element being disposed between an adjacent pair of the LED dies; a heat dissipation base for receiving and supporting the modularized LED base thereon and having two opposite peripheral sides respectively formed sliding grooves; a circuit unit disposed on the heat dissipation base in such a manner that the circuit is located adjacent to one side of the recess; an optical layer disposed over and covering the illumination unit and the bridging unit; a protection layer disposed over and covering the optical layer; and a diffusion shield disposed above the heat dissipation base and having two peripheral sides formed with downwardly and inwardly bent projections slidably engaging the sliding grooves of the heat dissipation base, thereby enclosing the LED dies therein such that the diffusion shield is located above and transversely to a light emitting path of the LED dies.

In the present invention, the recess in a modularized LED base is relatively narrow in width and since the optical layer and the protection layer only need to cover the relatively small width of the recess for shielding the LED units, the cost of material expense is greatly reduced and hence shortening the manufacture time.

One distinct feature of the present invention resides in that once the LED dies and the conductive elements are disposed on the bottom surface of the recess in the modularized LED base, the optical layer and the protection layer can be sequentially disposed over the LED dies, thereby finishing the production of the LED light tube of the present invention. Under such a situation, several processes of the prior are deleted, thereby shortening manufacture time and enhancing the production yield.

Another distinct feature of the present invention resides in that the LED dies coupled electrically via the conductive elements for various objective can shorten the distance between adjacent pair of the LED dies. Hence an appropriate adjustment can be conducted among the LED dies in order to achieve densely arrangement of the LED dies so that the LED light tubes thus produced can provide the outmost amount of brightness. At the same time, during the wire-bond operation, since the LED dies and the conducting elements can be kept at appropriate distance, since shorter wires are required for wire bond purpose, tangling among the wires can be avoided.

In accordance with the integrally formed and modularized concept, an LED base with the recess is modularized in such a manner that the illumination unit and the bridging unit are formed in the recess. The heat dissipation base is fabricated in such a manner to have a plurality of heat dissipation fins with increased surface to provide the outmost heat dissipation effect. In addition, a modularized wire-holding frame unit is provided according to the present invention for interconnecting electrically the circuit units and the conductive elements.

Therefore, owing to virtue of modularization of the LED base and the wire-holding frame unit, the LED light tubes of different longitudinal lengths can be formed for different specifications. Hence, the cost of material expense is greatly reduced and hence shortening the manufacture time.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a perspective view of a modularized LED base employed in an integrally formed light emitting diode (LED) light tube of the present invention;

FIG. 2a is a perspective view of a heat dissipation base employed in the integrally formed LED light tube of the present invention;

FIG. 2b is a perspective view of another heat dissipation base employed in the integrally formed LED light tube of the present invention;

FIG. 2c is a perspective view of yet another heat dissipation base employed in the integrally formed LED light tube of the present invention;

FIG. 3a illustrates a conductive element employed in the integrally formed LED light tube of the present invention;

FIG. 3b illustrates another conductive element employed in the integrally formed LED light tube of the present invention;

FIG. 4 is a perspective of the first embodiment of the integrally formed LED light tube of the present invention;

FIG. 5 is an exploded view of FIG. 4;

FIG. 6 is a perspective of the second embodiment of the integrally formed LED light tube of the present invention;

FIG. 7 shows a cross-section view of the third embodiment of the integrally formed LED light tube of the present invention; and

FIG. 8 shows a cross-section view of the fourth embodiment of the integrally formed LED light tube of the present invention.

### DETAILED DESCRIPTION OF THE PREFERRED EMBODIMENTS

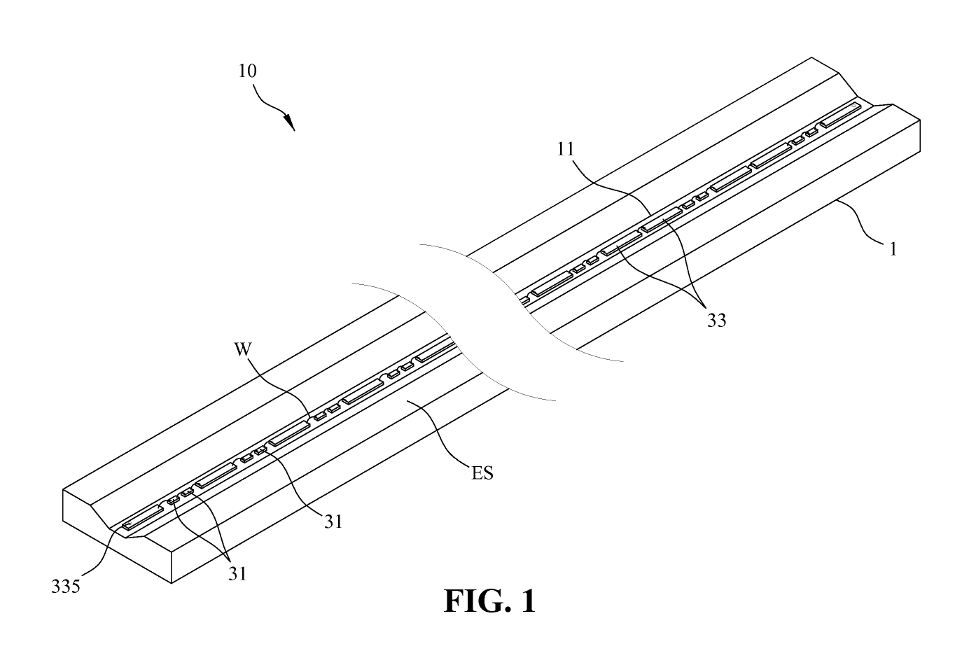

FIG. 1 shows a perspective view of a modularized LED base employed in an integrally formed light emitting diode (LED) light tube of the present invention. As shown in FIG. 1, the LED light tube 10 of module type according to the present invention includes a modularized LED base 1 having a light emitting side ES formed with a recess 11, at least one illumination unit and at least one bridging unit being fixed on a bottom surface of the recess 11. Preferably, the recess 11 has two lateral side walls extending inclinedly from two opposite sides of the bottom surface within a range of 40°˜65°.

In this embodiment, the illumination unit and the bridging unit are connected electrically via wire-bond technique, wherein the illumination unit is constituted by a plurality of LED dies 31 and the bridging unit is constituted by a plurality of conductive elements 33, one conductive element 33 is disposed between an adjacent pair of the LED dies 31 or one LED die 31 is disposed between an adjacent pair of the conductive elements 33. Note that a gold wire is applied for the wire-bond.

Note that arrangement among the LED dies 31 and the conductive elements 33 depends on the actual application, for instance, the arrangement can be one regular basis: one LED die 31 followed by one conductive element 33 and followed by one LED die 31. Alternatively, the arrangement can be one LED die 31 followed by two or three successive conductive element 33 or a series of LED dies 31 followed by a series of conductive elements 33. However, the arrangement of the above-mentioned elements should not be limited only thereto.

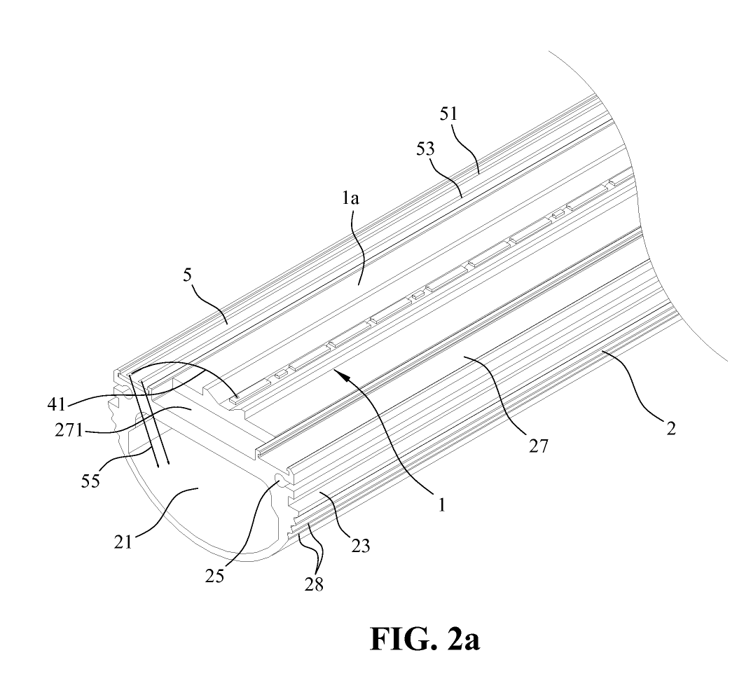

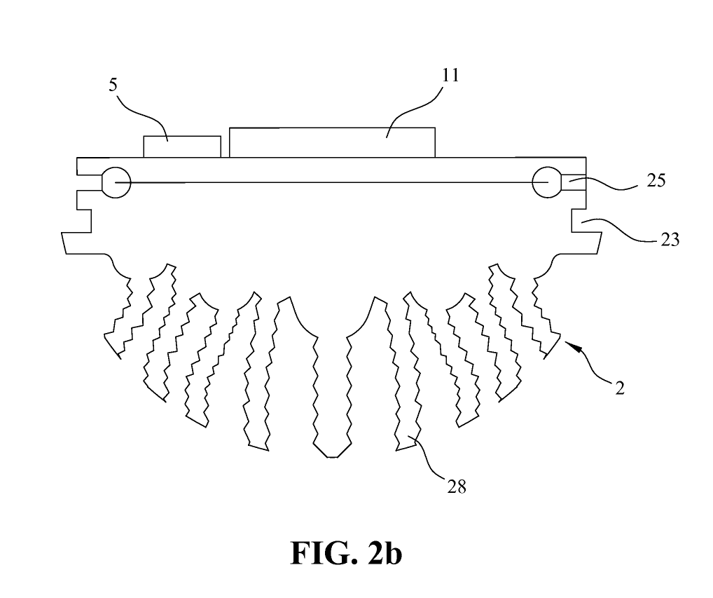

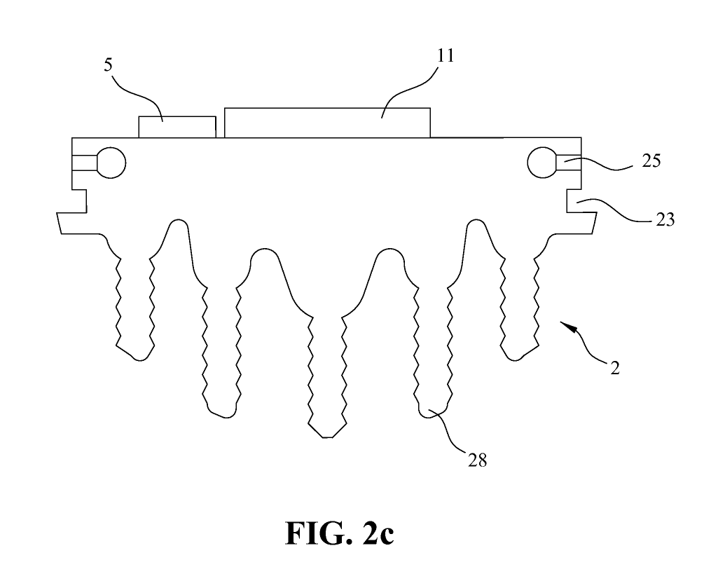

FIG. 2a is a perspective view of a heat dissipation base employed in the integrally formed LED light tube of the present invention. The LED light tube of the present invention further includes a heat dissipation base 2 for receiving and supporting the modularized LED base 1 thereon. The heat dissipation base 2 is preferably made from aluminum via extrusion method, has an interior portion that is semi-circle shape in cross-section and that defines a reception chamber 21 therein. A driver is disposed within the reception chamber 21 in the heat dissipation base 1 for driving the illumination unit.

The heat dissipation base 2 has two opposite peripheral sides respectively formed with a first pair of sliding grooves 23 and a second pair circular sliding grooves 25, their purpose will be explained in the following paragraphs.

The heat dissipation base 2 further has an upper portion that defines two sliding channels 27 at two peripheral portions thereof, and an intermediate channel 271 between the sliding channels 27. Preferably, the modularized LED base 1 has a positioning seat 1a fixed in the intermediate channel 271 in the heat dissipation base 1 (see FIG. 2a) such that the positioning seat 1a is located between the sliding channel 27.

Referring again to FIG. 2a, two circuit units 5 are disposed respectively within the sliding channels 27 in the heat dissipation base 1 such that the circuit units 5 are located adjacent to two sides of the recess 11. In this embodiment, the circuit units 5 are electrically connected to two of the conductive elements 3 via an external wire 41.

In the event, only a single circuit unit 5 is implemented, the positive and negative ends 51, 53 of the circuit unit 5 are connected electrically to a power line 55, which is latter coupled electrically the driver in the reception chamber 21. In this embodiment, a printed circuit board (PCB), a ceramic printed circuit board or other printed circuit serves as the conductive circuit 5.

Preferably, the positive and negative ends of the above circuit unit 5 are connected electrically to two of the conductive elements 33 via the external wire 41.

In the event, two circuit units 5 are implemented, one circuit unit 5 serves as the positive end while the other circuit unit 5 serves as the negative end connected respectively to the power line 55.

FIG. 2b is a perspective view of another heat dissipation base employed in the integrally formed LED light tube of the present invention. As best shown in FIG. 2b, the heat dissipation base 2 has a lower portion that surrounds the interior portion, and a plurality of heat dissipation fins 28 projecting outwardly and radially from the lower portion. Each of the heat dissipation fins 28 has external surface in wave configuration.

FIG. 2c is a perspective view of yet another heat dissipation base employed in the integrally formed LED light tube of the present invention. As best shown in FIG. 2c, the heat dissipation base 2 has a lower portion that is located below the interior portion and that is formed with a plurality of heat dissipation fins 28 projecting downwardly in a parallel manner. Each of the heat dissipation fins 28 has a truncated cone-shaped upper portion and a lower portion with external surface in a waveform configuration, the total structure thereof increases an overall surface area to enhance the heat dissipation effect of the LED light tube of the present invention.

An important factor to note in the above embodiment is that the middle heat dissipation fin 28 has the greatest surface area while the surface area of the heat dissipation fin decreases gradually outward with respect to the middle ones. By virtue of such configuration, undesired heat from the modularized LED base can be dissipated effectively to an exterior of the LED light tube of the present invention.

Another important factor to note is that the arrangement, configuration and size of the heat dissipation fins are to be designed in accordance with the actual need, and therefore should not be limited only to those described above.

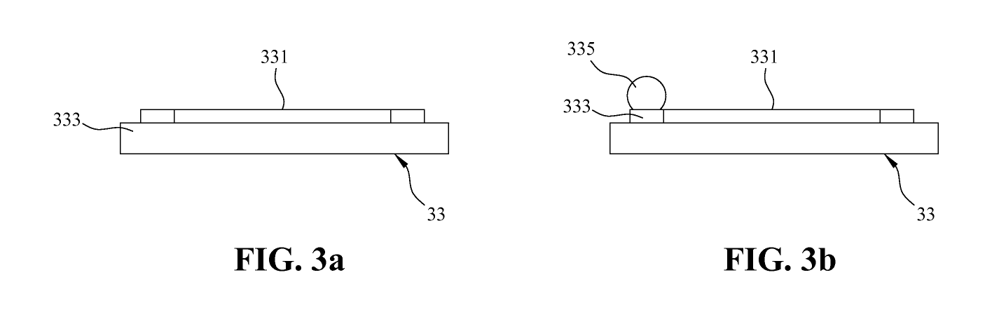

FIG. 3a illustrates a conductive element employed in the integrally formed LED light tube of the present invention and FIG. 3b illustrates another conductive element employed in the integrally formed LED light tube of the present invention. As best shown in FIG. 3a, each of the conductive elements 33 has a top surface formed with a conductive circuit 331 and two joining pads 333 at two opposite ends of the conductive circuit 331 to facilitate wire bonding or soldering purposes during the fabrication or manufacturing process.

Alternatively, each of the conductive elements 33 further includes at least one soldering ball 335 disposed on one joining pad 333 of a respective one of the conductive elements 33 to facilitate wire bonding or soldering purposes during the manufacturing process, as best shown in FIG. 3b. The soldering ball 335 is suitable for high temperature soldering purpose.

In this embodiment, each of the conductive elements 33 is a multi layer structure having a lower layer made from a silicone wafer, a ceramic chip, glass chip, or non-moisture materials. The lower layer is preferably constituted by from bottom to top a titanium layer and an aluminum layer, each is formed through bumping process.

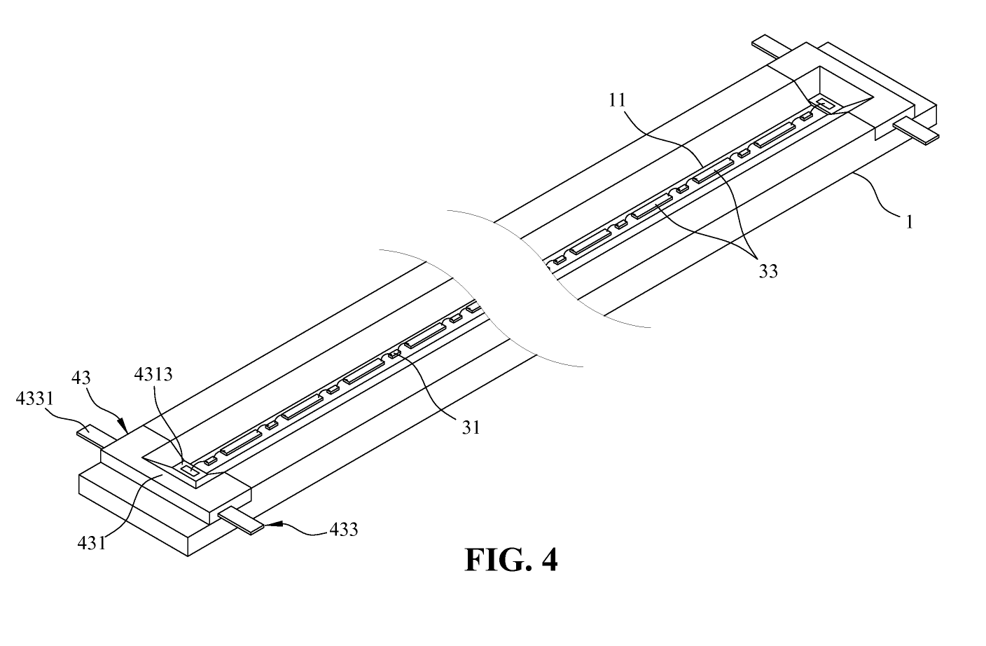

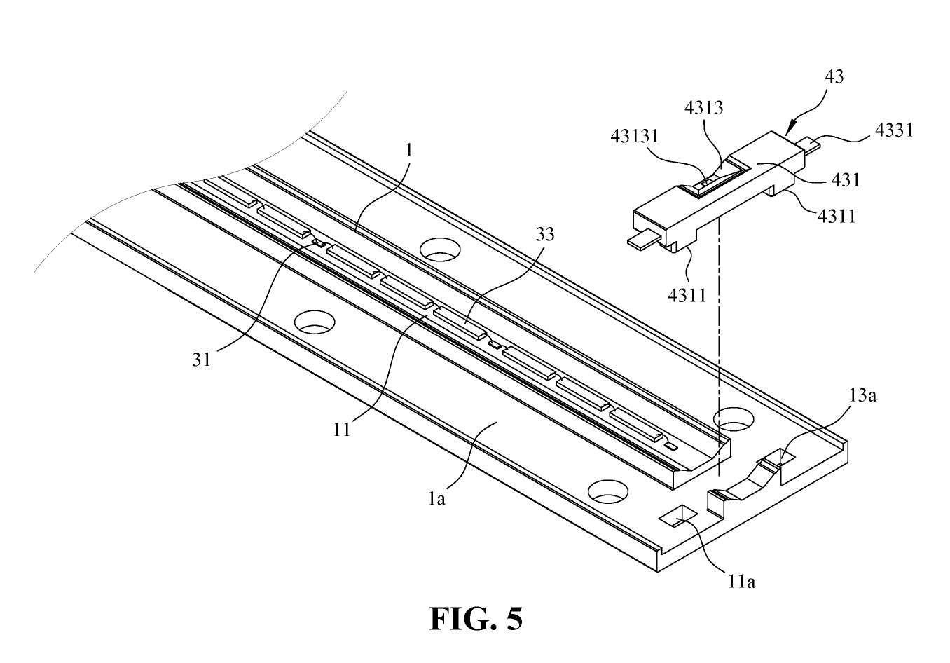

FIG. 4 is a perspective of the first embodiment of the integrally formed LED light tube of the present invention and FIG. 5 is an exploded view of FIG. 4, wherein, the positioning seat 1a of the modularized LED base 1 has two opposite ends respectively located adjacent to two opposite ends of the recess, at least one of the opposite ends of the positioning seat 1a is formed with first and second retention holes 11a, 13a. In one embodiment of the present invention, the first and second retention holes 11a, 13a can be formed through the heat dissipation base 2.

The first LED light tube of the present invention further includes a modularized wire-holding frame unit 43 interconnecting electrically two of the circuit units 5 and two of the conductive elements 33. The modularized wire-holding frame unit 43 is constituted by a wire-holding frame 431 and an encapsulated block 433 encapsulating partially the wire-holding frame 431 in such a manner that two conductive plates 4331 of the wire-holding frame 431 project outwardly from the encapsulated block 433 for electrically connected to the conductive elements 33.

In this embodiment, the encapsulated block 433 has two positioning legs 4311 extending into and engaging the first and second retention holes 11a, 13a in the positioning seat 1a to prevent untimely removal of the modularized wire-holding frame unit 43 from the modularized LED base 1. The encapsulated block 433 further has an upper groove 4313 in alignment with and in spatial communication with the recess 11 in the modularized LED base 1, and an access opening 43131 formed below the upper groove 4313 to permit extension through of the external wire 41. Note that the modularized wire-holding frame unit 43 is electrically isolated with the modularized LED base 1 in order to prevent occurrence of short-circuit therebetween.

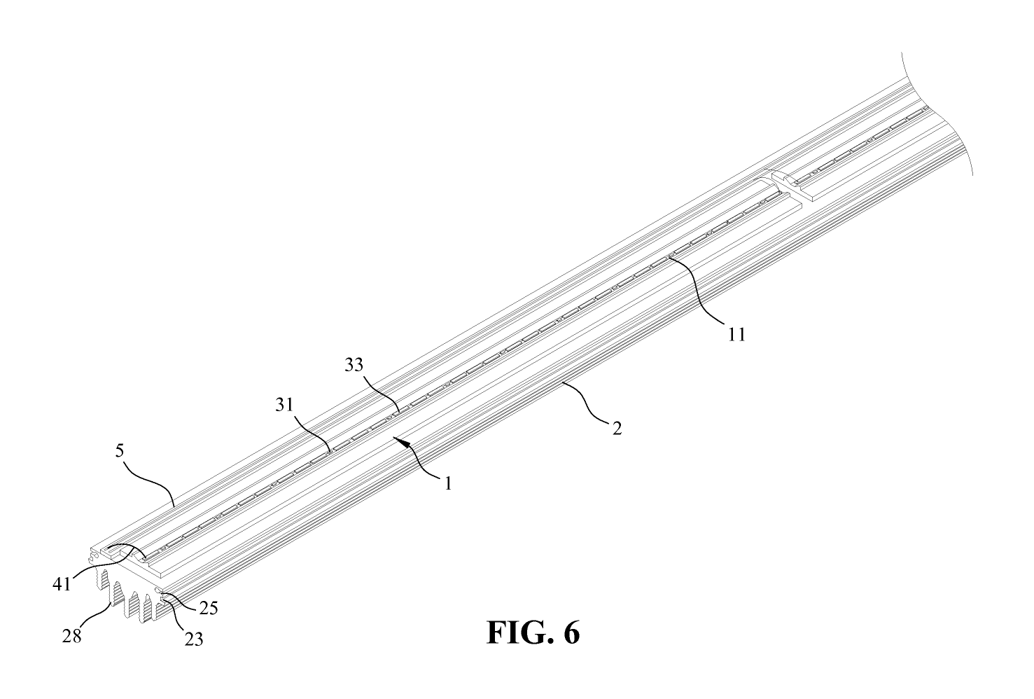

FIG. 6 is a perspective of the second embodiment of the integrally formed LED light tube of the present invention. The second embodiment is similar to the first embodiment in structure, except that a plurality of modularized LED bases 1 are mounted on the heat dissipation base 2.

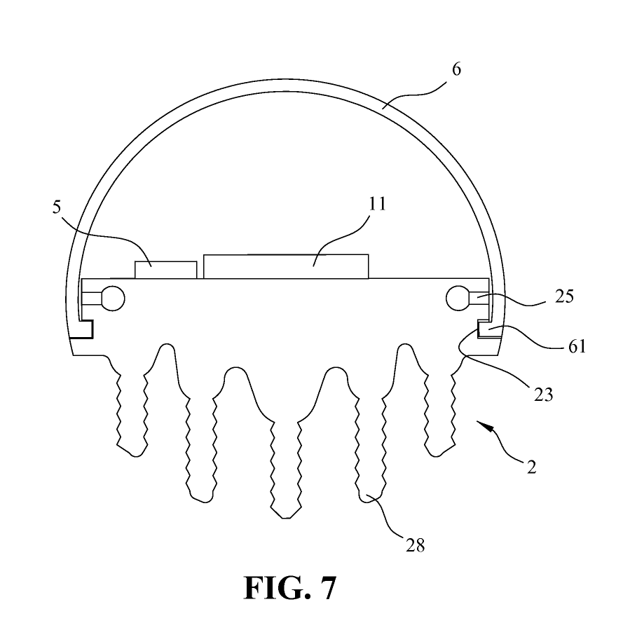

FIG. 7 shows a cross-section view of the third embodiment of the integrally formed LED light tube of the present invention. The third embodiment is similar to the first embodiment in structure, except that the third embodiment further includes a diffusion shield 6 of semi-circular cross-section, disposed above the heat dissipation base 2, and has two peripheral sides formed with downwardly and inwardly bent projections 61 slidably engaging the sliding grooves 23 of the heat dissipation base 2, thereby enclosing the LED dies 31 therein such that the diffusion shield 6 is located above and transversely to a light emitting path of the LED dies 31. Under this condition, the LED light tube of the present invention can provide the outmost amount of brightness and relatively large angle of light.

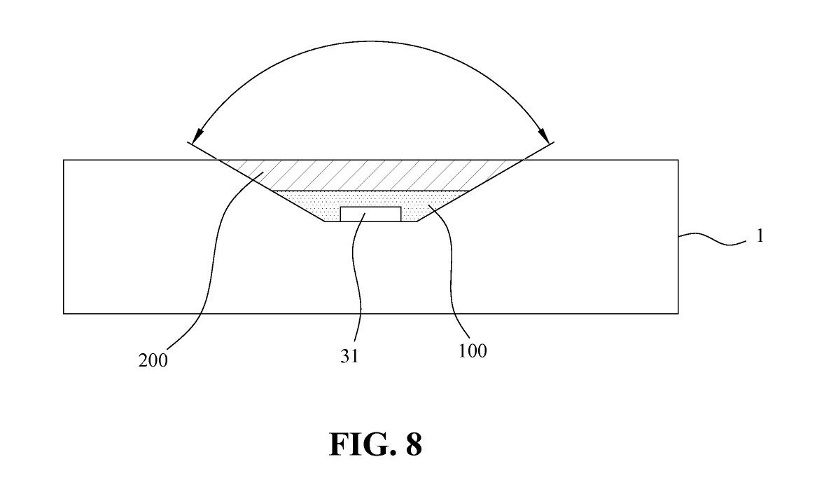

FIG. 8 shows a cross-section view of the fourth embodiment of the integrally formed LED light tube of the present invention. The fourth embodiment is similar to the first embodiment in structure; except that the fourth embodiment further includes an optical layer 100 disposed on the recess 11 of the heat dissipation base 2 in such a manner to cover the LED dies 31 and the conductive elements 33. In this embodiment, the optical layer 100 provides the optical effects relative to the LED dies 31, such as color mixing for the light emitted from the LED dies 31. The optical layer 100 is preferably made from fluorescent glue or material mixture consisting of fluorescent glue and silicon resin. The fourth embodiment further includes a protection layer 200 disposed above and covering the optical layer 100 so as to isolate the vapor and dust from getting interior of the optical layer 100. Preferably, the protection layer 200 is mainly made from silicon resin.

Referring to FIGS. 4 and 8 again, the optical layer 100 and the protection layer 200 cover the recess 11 in the modularized LED base 1 and the upper groove 4313 in the encapsulated block 433 so as to prevent the vapor and dust from getting interior of the optical layer 100, thereby preventing damage of the optical effects provided by the layer 100. From FIG. 4, note that the recess 11 and the upper groove 4313 are relatively narrow in width and since the optical layer and the protection layer only need to cover the relatively small width of the recess 11 and the upper groove 4313 for shielding the LED dies 31, the cost of material expense is greatly reduced and hence shortening the manufacture time.

One distinct feature of the present invention resides in that once the LED dies and the conductive elements are disposed on the bottom surface of the recess in the modularized LED, the optical layer and the protection layer can be sequentially disposed over the LED dies, thereby finishing the production of the LED light tube of the present invention. Under such a situation, several fabrication steps of the prior are deleted, thereby shortening the fabrication time and process, which in turn provides high product yield of the LED light tube of the present invention.

Another distinct feature of the present invention resides in that the LED dies coupled electrically via the conductive elements for various objective can shorten the distance between adjacent pair of the LED dies. Hence an appropriate adjustment can be conducted among the LED dies in order to achieve densely arrangement of the LED dies so that the LED light tubes thus produced can provide the outmost amount of brightness. At the same time, during the wire-bond operation, since the LED dies and the conducting elements can be kept at appropriate distance, since shorter wires are required for wire bond purpose, tangling among the wires can be avoided.

In accordance with the integrally formed concept, the modularized LED base with the recess, the illumination unit and the bridging unit are integrally fabricated, which is latter disposed on the heat dissipation base is fabricated in such a manner to have a plurality of heat dissipation fins of different lengths so as to dissipate heat therefrom. Hence, the LED light tube of the present invention survives a longer service life and provides high efficient brightness.

In addition, owing to modularization of the LED base and the wire-holding frame unit, and since they can be ready made in advance, the LED light tube of different specifications can be quickly produced. The cost of material expense is greatly reduced and hence shortening the manufacture time.

While the invention has been described in connection with what is considered the most practical and preferred embodiments, it is understood that this invention is not limited to the disclosed embodiments but is intended to cover various arrangement included within the spirit and scope of the broadest interpretation so as to encompass all such modifications and equivalent arrangements.

What is claimed is:

1. A light emitting diode (LED) light tube of module type, comprising:
a modularized LED base having a light emitting side formed with a recess, at least one illumination unit and at least one bridging unit being fixed on a bottom surface of said recess, said illumination unit and said bridging unit being connected electrically via wire-bond technique, wherein said illumination unit is constituted by a plurality of LED dies and said bridging unit is constituted by a plurality of conductive elements, one conductive element being disposed between an adjacent pair of said LED dies;
a heat dissipation base for receiving and supporting said modularized LED base thereon and having two opposite peripheral sides respectively formed sliding grooves;
a circuit unit disposed on said heat dissipation base in such a manner that said circuit is located adjacent to one side of said recess;
an optical layer disposed over and covering said illumination unit and said bridging unit;
a protection layer disposed over and covering said optical layer; and
a diffusion shield disposed above said heat dissipation base and having two peripheral sides formed with downwardly and inwardly bent projections slidably engaging said sliding grooves of said heat dissipation base, thereby enclosing said LED dies therein such that said diffusion shield is located above and transversely to a light emitting path of said LED dies.

2. The LED light tube according to claim 1, wherein said recess has two lateral side walls extending inclinedly from two opposite sides of said bottom surface within a range of 40°˜65°.

3. The LED light tube according to claim 1, wherein said heat dissipation base is made from aluminum via extrusion method, has an interior portion that is semi-circle shape in cross-section and that defines a reception chamber therein, and an upper portion that defines two sliding channels at two peripheral portions thereof, one of said sliding channels receiving said circuit unit there, and an intermediate channel between said sliding channels for receiving said modularized LED base therein.

4. The LED light tube according to claim 3, further comprising a driver disposed within said reception chamber in said heat dissipation base for driving said illumination unit.

5. The LED light tube according to claim 1, wherein said heat dissipation base has a lower portion that surrounds said interior portion and a plurality of heat dissipation fins projecting outwardly and radially from said lower portion, each of said heat dissipation fins having external surface in wave configuration.

6. The LED light tube according to claim 1, wherein said heat dissipation base has a lower portion that is located below said interior portion and that is formed a plurality of heat dissipation fins projecting downwardly in parallel manner, each of said heat dissipation fins having a truncated cone-shaped upper portion and a lower portion with external surface in wave configuration.

7. The LED light tube according to claim 1, wherein said circuit unit has positive and negative ends connected electrically to two of said conductive elements via an external wire.

8. The LED light tube according to claim 7, wherein each of said conductive elements has a top surface formed with a conductive circuit and two joining pads at two opposite ends of the conductive circuit to facilitate wire bonding purpose.

9. The LED light tube according to claim 8, further comprising a soldering ball disposed on one of said joining pads of a respective one of said conductive elements, said external wire having one end electrically connected to said soldering ball.

10. The LED light tube according to claim 9, wherein each of said conductive elements is a multi layer structure having a lower layer made from a silicone wafer, a ceramic chip or glass chip, said lower layer being constituted by from bottom to top a titanium layer and an aluminum layer, each being formed through bumping process.

11. The LED light tube according to claim 1, further comprising a modularized wire-holding frame unit interconnecting electrically two of said circuit units and two of said conductive elements.

12. The LED light tube according to claim 11, wherein said modularized LED base includes a positioning seat that is disposed on said heat dissipation base and that has two opposite ends respectively located adjacent to two opposite ends of said recess, at least one of said opposite ends of said positioning seat being formed with first and second retention holes, said modularized wire-holding frame unit including a wire-holding frame and an encapsulated block encapsulating partially said wire-holding frame in such a manner that at least one conductive plate of said wire-holding frame project outwardly from said encapsulated block for electrically connected to one of said conductive elements, said encapsulated block having two positioning legs extending into and engaging said first and second retention holes in said positioning seat to prevent untimely removal of said modularized wire-holding frame unit from said modularized LED base, said encapsulated block further having an upper groove in alignment with and in spatial communication with said recess in said modularized LED base and an access opening formed below said upper groove to permit extension through of said external wire.
